(19) United States
(12) Patent Application Publication
(10) Pub. No.: US 2008/0302826 A1
(43) Pub. Date: Dec. 11, 2008

(54) Plunger tube

(76) Inventor: Joseph Rich, JR., Blairstown, NJ (US)

Correspondence Address: LITMAN LAW OFFICES, LTD., POST OFFICE BOX 15035, CRYSTAL CITY STATION, ARLINGTON, VA, 22215-0035, US

(21) Appl. No.: 12/155,201

(22) Filed: May 30, 2008

Related U.S. Application Data
(60) Provisional application No. 60/933,890, filed on Jun. 9, 2007.

(51) Int. Cl. B67D 5/38; G01F 11/00

(52) U.S. Cl. 222/158; 222/386

(57) ABSTRACT

The plunger tube includes a flexible tubular housing having a closed bottom and a top, the top including an opening allowing contents of the tube to be dispensed therefrom. A feed plunger is permanently disposed inside the tubular housing, the feed plunger having dual tapered wiping blades that hug the tube inner walls to aid in dispensing contents adhered to the tube walls. The wiping blades also prevent the plunger from sliding out of axial alignment with the tube. A tube cap is removably disposed on the top to seal and alternatively unseal the opening in the top. When a user squeezes and displaces the plunger upward from the outside of the tube, a corresponding amount of tube contents is forcibly ejected through the top opening. Advantageously, the internal plunger assists in complete usage of the tube contents.

### CROSS-REFERENCE TO RELATED APPLICATION

This application claims the benefit of U.S. Provisional Patent Application Ser. No. 60/933,890, filed Jun. 9, 2007.

### BACKGROUND OF THE INVENTION

1. Field of the Invention

The present invention relates to improvements in dispensing devices, and more specifically to an improved dispensing tube.

2. Description of the Related Art

In the use of plastic squeeze tubes it is common to provide a squeeze tube with a closed end, an open end and a closure that threads or snaps on the open end of the squeeze tube. It remains problematic, however, to dispense a measured amount from such a tube. Additionally, as more of the tube contents is expended it becomes more difficult for a user to squeeze out the remaining contents without leaving some of the contents on the inside walls of the tube. Moreover, when the tube is squeezed excessively to get the last of the contents out, the tube often ruptures, creating a mess and more waste of tube content.

It would be desirable to provide a flexible squeeze tube and dispensing system capable of measuring out a predetermined amount of contents from the tube. Moreover, it would be desirable to provide a squeeze tube in which less of the tube contents are wasted.

Thus, a plunger tube solving the aforementioned problems is desired.

### SUMMARY OF THE INVENTION

The plunger tube includes a flexible tubular housing having a closed bottom and a top, the top including an opening allowing contents of the tube to be dispensed therefrom. A hollow feed plunger is permanently disposed inside the tubular housing, the hollow feed plunger having dual tapered wiping blades that hug the tube inner walls to aid in dispensing contents adhered to the tube walls. The wiping blades also prevent the plunger from sliding out of axial alignment with the tube.

A tube cap is removably disposed on the top to seal and alternatively unseal the opening in the top. When a user squeezes the plunger from the outside of the tube, the resilient plunger travels upward through the tube thereby displacing contents up through the top opening to dispense a desired amount of contents from the tube. Advantageously, the internal plunger assists in complete usage of the tube contents.

These and other features of the present invention will become readily apparent upon further review of the following specification and drawings.

### BRIEF DESCRIPTION OF THE DRAWINGS

FIG. 1 is a section view of the plunger tube according to the present invention.

FIG. 2 is a bottom view of the plunger tube according to the present invention.

FIG. 3 is a top view of the plunger tube with the flip top open according to the present invention.

FIG. 4 is a perspective view of the internal plunger of the plunger tube according to the present invention.

FIG. 5 is a perspective view showing measurement markings disposed on the plunger tube according to the present invention.

Similar reference characters denote corresponding features consistently throughout the attached drawings.

### DETAILED DESCRIPTION OF THE PREFERRED EMBODIMENT

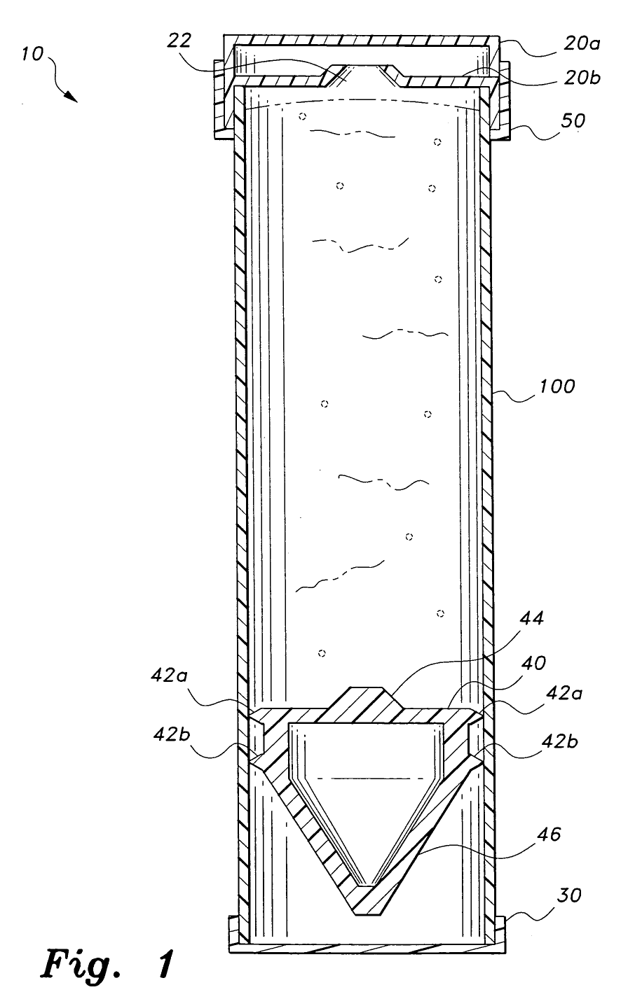

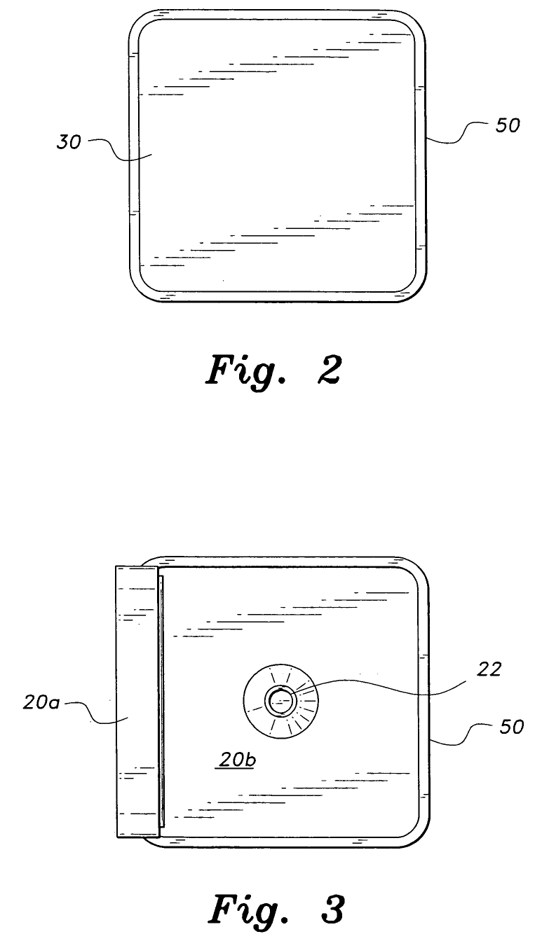

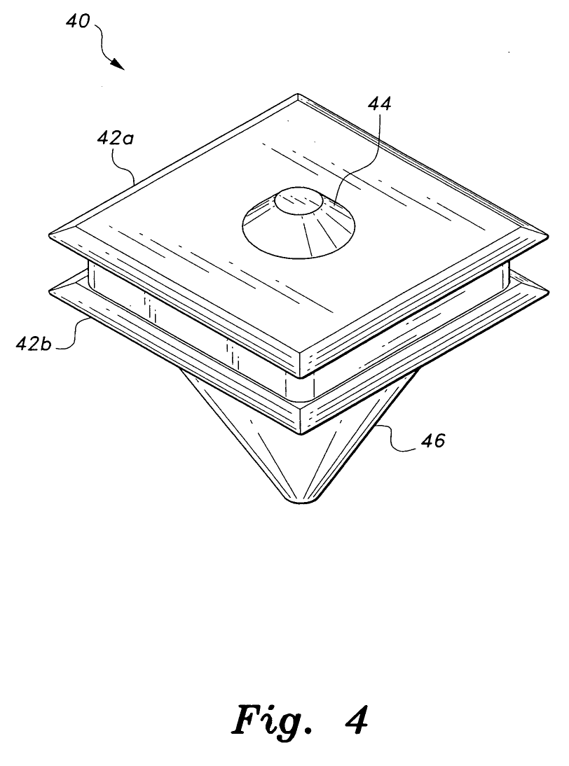

As shown in FIGS. 1-3, the present invention 10 provides a flexible tubular housing 100 having a bottom closed by bottom seal 30 and a top 20b, the top including an opening 22 allowing contents of the tube to be dispensed therefrom. A feed plunger 40 is permanently disposed inside the tubular housing 100, the feed plunger 40 having upper wiping blade periphery 42a and lower wiping blade periphery 42b that hug the inside wall(s) of tubular housing 100 thereby constraining the plunger 40 to axial alignment with the tube. The shape of plunger 40 is most clearly shown in FIG. 4.

A tube cap 20a is pivotally disposed over the top 20b to seal and alternately unseal the opening 22 in the top 20b. When tube body 100 is squeezed from proximate the bottom seal 30 towards the top 20b, the plunger 40 is displaced in an upward direction towards the top 20b to forcibly eject the tube contents from the opening 22 at the top 20b. Advantageously, the internal plunger 40 assists in complete usage of the tube contents since the contents cannot slip behind the plunger 40.

While a variety of shapes are contemplated in this disclosure, the plunger tube 10 shown in FIG. 1 has a square cross section. Moreover, the bottom 30 and top 20b are square shaped.

As most clearly shown in FIGS. 1 and 4, a lower portion 46 of plunger 40 is substantially cone shaped, a maximum cross section thereof is tangentially in contact with an inner periphery of tubular housing 100. Similarly, an upper portion of plunger 40 is substantially the same shape as a cross section of the tubular housing 100, an outer periphery of the upper portion of plunger 40 being tangentially in contact with the inner periphery of tubular housing 100.

First and second wiping blade peripheries 42b, 42a are formed from the maximum cross section of the lower portion of plunger 40, and from the outer periphery of the upper portion of plunger 40, respectively. The wiping blade peripheries aid in efficiently and effectively discharging the maximum amount of contained product.

Preferably, the feed plunger 40 is resilient. The feed plunger 40 may, though not necessarily, be hollow, the hollowness being a design choice to aid in efficient manufacturing of the same. The feed plunger 40 has a solid boss 44 that fits into the opening 22 as a user applies pressure at conical end of the plunger to squeeze out the last contents of tube 100.

As shown in FIG. 1, the cap 20a is pivotally connected in relation to the housing body 100 so that a user can flip the cap up and away from the top opening 22 to facilitate dispensing of the tube contents. A seal band 50 is interoperably disposed in relation to the cap 20a and the tubular housing body top 20b, the seal band 50 sealing off the top 20b of the tube when the cap 20a is closed.

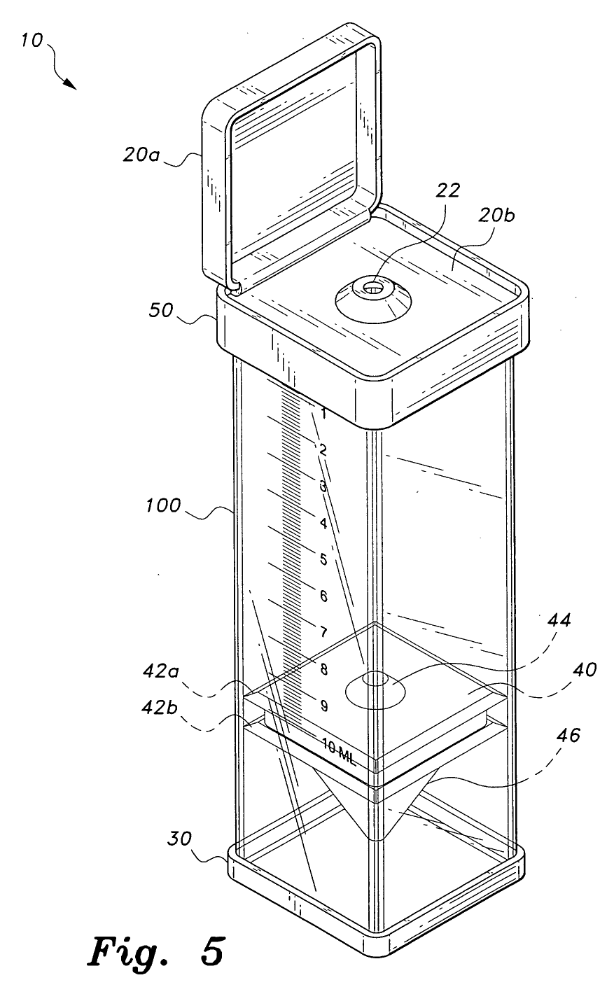

In manufacturing, the tube 100 is filled from an open bottom portion of the tube, then the plunger 40 is inserted, then the bottom seal 30 is attached at the bottom. Thus there is no material trapped in the conical interface between the cone portion 46 of plunger 40 and the walls of tube 100. While a round version of tube 100 may be used, the square cross sectional configuration is more “green” in that the tube 100 becomes stackable in storage boxes, on store shelves, or the like, without having to be packaged in a cardboard carton. As shown in FIG. 5, Markings comprising numbers, gradation marks, or other indicia may be manufactured on a transparent version of tube 100. The markings provide a means for a user to measure out a precise amount of the tube contents since the user can see the progress of movement of plunger 40 in relation to the markings as the user squeezes the tube 100. Preferably the components of plunger tube 10 are manufactured from polyethylene terephthalate (PET) plastics or similar material.

It is to be understood that the present invention is not limited to the embodiment described above, but encompasses any and all embodiments within the scope of the following claims.

I claim:

1. A plunger tube, comprising:
a flexible tubular housing the tubular housing having a closed bottom and a top, an opening extending from the top, the opening allowing contents of the tube to be dispensed therefrom; and
a resilient, feed plunger permanently disposed inside the tubular housing, the feed plunger having dual tapered wiping blade peripheries therein, the dual tapered wiping blade peripheries constraining the plunger in axial alignment with the tube; a tube cap, the tube cap removably disposed over the opening of the top;
wherein when the feed plunger is squeezed and displaced towards the top a corresponding amount of the tube contents is forcibly ejected from the opening of the top.

2. The plunger tube according to claim 1, wherein a substantial portion of the tubular housing has a square cross section.

3. The plunger tube according to claim 1, wherein a lower portion of the hollow feed plunger is substantially cone shaped, a maximum cross section thereof being tangentially in contact with an inner periphery of the tubular housing.

4. The plunger tube according to claim 1, wherein an upper portion of the plunger is substantially the same shape as a cross section of the tubular housing, a periphery of the upper portion of the plunger being tangentially in contact with an inner periphery of the tubular housing.

5. The plunger tube according to claim 3, wherein a first of the dual tapered wiping blade peripheries is formed from the maximum cross section of the lower portion of the hollow plunger.

6. The plunger tube according to claim 4, wherein a second of the dual tapered wiping blade peripheries is formed from the periphery of the upper portion of the hollow plunger.

7. The plunger tube according to claim 1, wherein the cap is pivotally connected in relation to the housing body, the cap flipping up and away from the top opening to facilitate dispensing of the tube contents.

8. The plunger tube according to claim 7, further comprising a seal band interoperably disposed in relation to the cap and the tubular housing body top, the seal band sealing off the top of the tube when the cap is closed.

9. The plunger tube according to claim 1, wherein a boss extends from the feed plunger, the boss forcibly ejecting a last portion of the contents of the tube from the tube top opening.

10. The plunger tube according to claim 1, wherein components of the plunger tube are made from a thermoplastic polymer material.

11. The plunger tube according to claim 1, wherein the plunger tube is made of a material allowing the tube contents to be viewed.

12. The plunger tube according to claim 11, further comprising indicia disposed on the tube body, the indicia allowing a user to measure out the amount of contents ejected from the tube.
